(19) United States
(12) Patent Application Publication
(10) Pub. No.: US 2026/0169782 A1
(43) Pub. Date: Jun. 18, 2026

(54) Limiting Access to Shared Virtual Storage Using Allowed Virtual Addresses

(71) Applicant: International Business Machines Corporation, Armonk, NY (US)

(72) Inventors: Oliver Witham, Kingclere (GB); Douglas Eric Burns, Didcot (GB); James Oliver Hurst, Eastleigh (GB); Simon Francis Page, Southampton (GB)

(21) Appl. No.: 18/984,054

(22) Filed: Dec. 17, 2024

(51) Int. Cl. G06F 9/455

(52) U.S. Cl. CPC G06F 9/45558; G06F 2009/45583

(57) ABSTRACT

Limiting access to a shared virtual storage address range is provided. It is determined whether a current instruction address of an access requesting thread is contained in a list of allowed virtual addresses permitted to access an address range of shared virtual storage allocated to an allocating thread. In response to determining that the current instruction address of the access requesting thread is contained in the list of allowed virtual addresses permitted to access the address range of the shared virtual storage allocated to the allocating thread, a request to access the address range of the shared virtual storage by the access requesting thread is granted.

### BACKGROUND

The disclosure relates generally to shared virtual storage and more specifically to managing shared virtual storage usage.

Shared virtual storage is a virtual storage repository that may take the form of any type of virtual storage used by, for example, threads. In other words, shared virtual storage allows multiple threads to share a common virtual storage location.

The range of virtual addresses that an operating system assigns to a running thread is called an address space. This is the area of contiguous virtual addresses available for executing instructions and storing data. The range of virtual addresses in an address space starts at zero and can extend to the highest address permitted by the operating system. Operating systems provide each thread with a unique address space and maintain the distinction between the threads and data belonging to each address space.

### SUMMARY

According to one illustrative embodiment, a method is provided. The method determines whether a current instruction address of an access requesting thread is contained in a list of allowed virtual addresses permitted to access an address range of shared virtual storage allocated to an allocating thread. In response to determining that the current instruction address of the access requesting thread is contained in the list of allowed virtual addresses permitted to access the address range of the shared virtual storage allocated to the allocating thread, a request to access the address range of the shared virtual storage by the access requesting thread is granted. According to other illustrative embodiments, a computer system and computer program product are provided.

### BRIEF DESCRIPTION OF THE DRAWINGS

FIG. 1 is a pictorial representation of a computing environment in which illustrative embodiments may be implemented;

FIG. 2 is a diagram illustrating an example of a shared virtual storage management system in accordance with an illustrative embodiment;

FIG. 3 is a flowchart illustrating a process for protecting a shared virtual storage address range from storage overlay in accordance with an illustrative embodiment; and

FIGS. 4A-4B are a flowchart illustrating a process for limiting access to a shared virtual storage address range in accordance with an illustrative embodiment.

### DETAILED DESCRIPTION

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A CCP embodiment is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Some embodiments of the present disclosure may include a method to limit access to shared storage using the thread's current instruction address. The method may include a task attempting to access shared storage. The method may include completing pre-existing tests to check if the requester has the required privileges to access the storage; in some embodiments, the operating system or storage manager may complete the pre-existing tests. The method may include determining whether the requester has the required privileges to access the storage. If the requester has the required privileges, the method may include granting the access request; if the requester does not have the required privileges, then the method may include rejecting the access request.

In some embodiments of the present disclosure, an additional check may be made to see if the range of storage being requested is protected by one or more rules. If no additional protection is provided, then the storage access request may be granted. However, if additional protection is provided, a list of allowed storage ranges may be fetched. If the address is included in the permitted range, then the method may include allowing the storage access request; if the address is not included in the permitted range, then the method may include rejecting the storage access request.

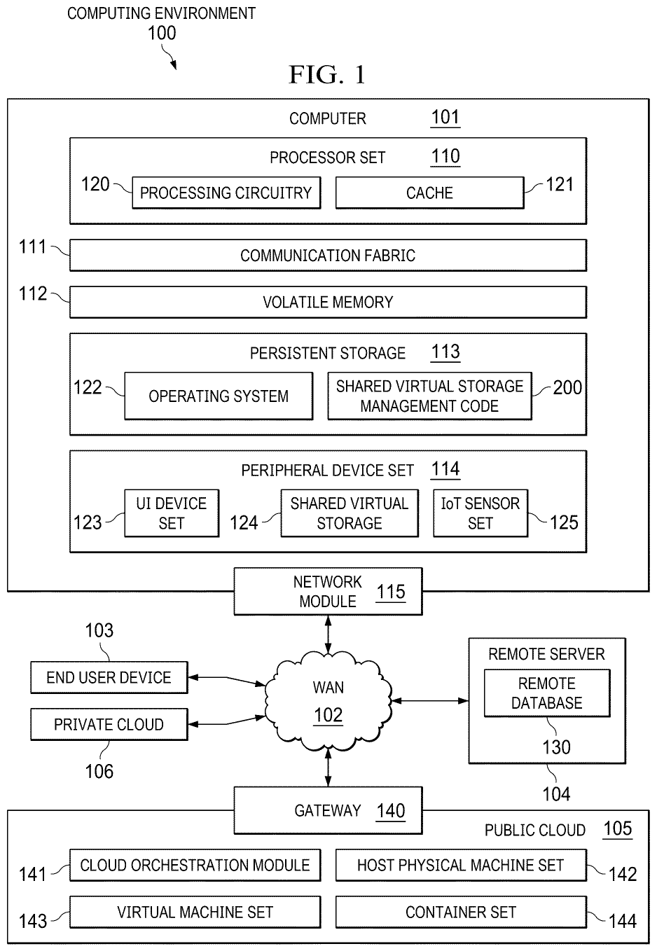

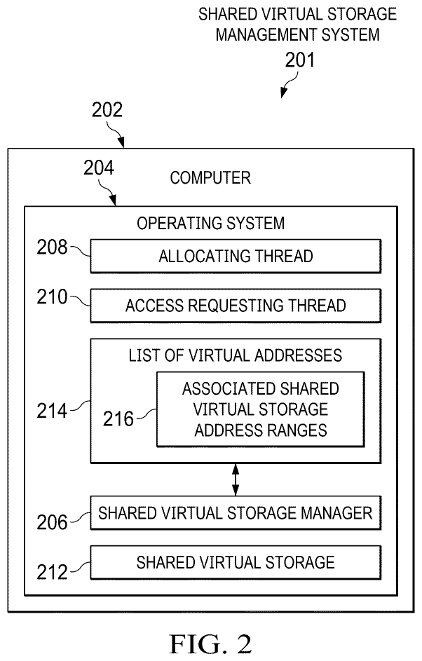

With reference now to the figures, and in particular, with reference to FIG. 1 and FIG. 2, diagrams of data processing environments are provided in which illustrative embodiments may be implemented. It should be appreciated that FIG. 1 and FIG. 2 are only meant as examples and are not intended to assert or imply any limitation with regard to the environments in which different embodiments may be implemented. Many modifications to the depicted environments may be made.

FIG. 1 shows a pictorial representation of a computing environment in which illustrative embodiments may be implemented. Computing environment 100 contains an example of an environment for the execution of at least some of the computer code involved in performing the inventive methods of illustrative embodiments, such as shared virtual storage management code 200. For example, shared virtual storage management code 200 may limit access to particular shared virtual storage address ranges allocated to particular allocating threads using different lists of virtual addresses permitted to access those particular shared virtual storage address ranges corresponding to those particular allocating threads. However, it should be noted that threads are used herein as an example only and not as a limitation on illustrative embodiments. For example, illustrative embodiments may allow applications, tasks, processes, or the like to allocate different address ranges in shared virtual storage as well.

Shared virtual storage management code 200 utilizes the current instruction address of a running thread to determine whether the running thread should be allowed access to a particular memory page in shared virtual storage to potentially avoid storage overlay. It should be noted that operating systems provide storage protection by utilizing storage protect keys in order to determine which threads are allowed access to which areas of shared virtual storage.

In some embodiments, shared virtual storage management code 200 extends the shared virtual storage protection provided by storage protect keys by also using a list of allowed virtual addresses permitted to access a particular shared virtual storage address range. For example, when a thread requests access to a memory page in shared virtual storage, shared virtual storage management code 200 validates the requesting thread's current instruction address against the list of allowed virtual addresses permitted to access an address range in the shared virtual storage where that particular memory page is located. If the virtual address of the current instruction of the requesting thread for that particular memory page in shared virtual storage is found in the allowed list of virtual addresses, then shared virtual storage management code 200 grants the access to that particular memory page; otherwise, shared virtual storage management code 200 denies access. Shared virtual storage management code 200 enables a thread to register its own list of allowed virtual addresses permitted to access an address range of shared virtual storage allocated to that particular thread to prevent other certain threads from using that set of allowed virtual addresses to prevent storage overlays.

In addition to shared virtual storage management code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and shared virtual storage management code 200, as identified above), peripheral device set 114 (including user interface (UI) device set 123, shared virtual storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a mainframe computer, quantum computer, desktop computer, laptop computer, tablet computer, smart phone, or other wearable computer, or any other form of computer or mobile device now known or to be developed in the future that is capable of, for example, running a program, accessing a network, and querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods of illustrative embodiments may be stored in shared virtual storage management code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the internet. In various embodiments, UI device set 123 may include components such as a display screen, speaker, microphone, wearable devices (such as smart glasses and smart watches), keyboard, mouse, printer, touchpad, and haptic devices.

Shared virtual storage 124 can be read by both authorized and unauthorized threads, but can be allocated and released only by authorized threads. Each virtual address space in the system has its own private storage but shares shared virtual storage with the other virtual address spaces. Although shared virtual storage is considered part of a virtual address space, in many ways it behaves as if it were not. For example, if an address space is swapped out, only the private storage is swapped out. Private storage can be accessed from another address space only by using access registers or cross-memory services; whereas shared virtual storage can be accessed by threads in other address spaces.

IoT sensor set 125 is made up of sensors that can be used in Internet of Things applications. For example, one sensor may be a thermometer, and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (e.g., embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (e.g., the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

EUD 103 is any computer system that is used and controlled by an end user (e.g., a system administrator who manages shared virtual storage operation on computer 101), and may take any of the forms discussed above in connection with computer 101. EUD 103 typically receives helpful and useful data from the operations of computer 101. For example, in a hypothetical case where computer 101 is designed to provide a shared virtual storage management recommendation to the end user, this recommendation would typically be communicated from network module 115 of computer 101 through WAN 102 to EUD 103. In this way, EUD 103 can display, or otherwise present, the shared virtual storage management recommendation to the end user. In some embodiments, EUD 103 may be a client device, such as a thin client, heavy client, mainframe computer, desktop computer, laptop computer, tablet computer, smart phone, smart glasses, virtual reality device, and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a shared virtual storage management recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single entity. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

As used herein, when used with reference to items, “a set of” means one or more of the items. For example, a set of clouds is one or more different types of cloud environments. Similarly, “a number of,” when used with reference to items, means one or more of the items. Moreover, “a group of” or “a plurality of” when used with reference to items, means two or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

A common issue on computers (e.g., mainframes) is storage or memory overlays caused by rogue threads or software bugs that unintentionally trash shared virtual storage areas that are actively used by other threads or software. On platforms, it is feasible to be able to write anything to any piece of storage owned by any thread. On these platforms, storage is commonly protected by the use of storage protect keys to manage cross storage operations between threads. However, storage overlays can still occur using storage protect keys. In addition, when storage overlays do occur the storage overlays can be difficult to diagnose and identify the root cause. Overlaying means transferring a block of code or other data into shared virtual storage, replacing what was already stored in that shared virtual storage.

A thread's current storage protect key is stored in a program status word. A program status word is a 128-bit data area in a processor. The program status word indicates a system's general status in relation to the currently running thread. For example, the program status word indicates whether the processor is waiting or processing, whether the processor can receive I/O interrupts or not, the virtual address of the current instruction of the thread to be executed, and the like. Each processor has only one current program status word. Thus, only one thread can execute on a processor at a time. Access to shared virtual storage is governed by comparing control information associated with shared virtual storage against the storage protect key in the thread's program status word. However, it should be noted that the program status word is an operating system concept and that illustrative embodiments are not limited to utilizing program status words. In other words, illustrative embodiments may store storage protect keys anywhere in the system.

Illustrative embodiments extend this standard shared virtual storage protection (e.g., storage protect keys) by additionally checking the virtual address of an access requesting thread's current instruction, which is stored in the program status word, against a list of allowed virtual addresses permitted to access a range of shared virtual storage addresses allocated to an allocating thread. It should be noted that the access requesting thread may be the same as the allocating thread.

Operating systems utilize shared virtual storage as a standard way for threads running on these operating systems to interact with each other. Illustrative embodiments utilize a mechanism to prevent the chances of storage overlays, saving time and money for customers and diagnosis time for system administrators, support engineers, or the like.

For example, illustrative embodiments provide additional protection to an allocating thread by enabling the allocating thread to protect one or more areas of shared virtual storage to reduce the potential for a rogue thread or a software bug to overwrite any of the shared virtual storage areas allocated to that thread. Illustrative embodiments achieve this additional protection by the utilizing a list of allowed virtual addresses that are permitted to interact with the one or more areas (e.g., address ranges) of shared virtual storage that are allocated to the allocating thread. When a virtual address of a current instruction executed from any source (e.g., an access requesting thread) attempts to access that portion of shared virtual storage allocated to the allocating thread, illustrative embodiments check whether the virtual address of the current instruction executed by the access requesting thread is included in the list of allowed virtual addresses permitted to access any of the areas of shared virtual storage allocated to the allocating thread.

It should be noted that slips are useful for capturing documentation to diagnose storage overlays. However, some understanding of the conditions needed to create a storage overlay must be obtained before being able to create an effective slip. Additionally, slips can only be created after a storage overlay has occurred. As a result, reoccurrence of a storage overlay is needed for a slip to trigger. It should be noted that slips also are an operating system concept and that illustrative embodiments are not limited to utilizing slips.

Memory protection also provides a mechanism to programmatically protect storage within the scope of a thread's ability to read from or write to that storage. However, memory protection does not provide protection in shared virtual storage environments where another thread may have access to the same underlying storage being used.

Subspaces provides some additional protection against inadvertent storage overlays by threads that share a virtual address space. Subspaces build on top of the normal virtual address space isolation by providing a more granular scope (i.e., a subspace). However, subspaces do not solve issues related to cases where valid thread usage needs a broad scope of access (e.g., shared virtual storage). In addition, subspaces are an operating system concept and illustrative embodiments are not limited to utilizing subspaces. Thus, further narrowing of the scope of general thread access does not help. Illustrative embodiments instead provide a control which is independent of the existing mechanisms noted above and allow the allocating thread to explicitly specify which particular virtual addresses can access a given shared virtual storage address range irrespective of system scope, address space scope, and storage protect key.

Thus, illustrative embodiments provide one or more technical solutions that overcome a technical problem with storage overlays in shared virtual storage caused by threads. As a result, these one or more technical solutions provide a technical effect and practical application in the field of shared virtual storage.

With reference now to FIG. 2, a diagram illustrating an example of a shared virtual storage management system is depicted in accordance with an illustrative embodiment. Shared virtual storage management system 201 is a system of hardware and software components for limiting access to certain shared virtual storage address ranges using different lists of virtual addresses permitted to access different shared virtual storage address ranges allocated to different allocating threads. Shared virtual storage management system 201 is implemented in computer 202. Computer 202 may be, for example, computer 101 in FIG. 1.

Computer 202 includes operating system 204. Operating system may be, for example, operating system 122 in FIG. 1. In this example, operating system 204 includes shared virtual storage manager 206. Shared virtual storage manager 206 may be implemented by, for example, shared virtual storage management code 200 in FIG. 1.

In this example, allocating thread 208 and access requesting thread 210 are running on operating system 204. However, it should be noted that allocating thread 208 and access requesting thread 210 are intended as examples only and not as limitations on illustrative embodiments. For example, any number and type of threads can be running on operating system 204.

Allocating thread 208 has allocated a set of one or more address ranges in shared virtual storage 212. As a result, allocating thread 208 registers the set of address ranges allocated to allocating thread 208 with shared virtual storage manager 206 to protect that set of addresses ranges of shared virtual storage 212 from storage overly by unauthorized threads requesting access. In addition, allocating thread 208 provides list of virtual addresses 214 and associated shared virtual storage address ranges 216 to shared virtual storage manager 206.

List of virtual addresses 214 contains the set of virtual addresses permitted by allocating thread 208 to access the set of address ranges of shared virtual storage 212 allocated to allocating thread 208. Associated shared virtual storage address ranges 216 represent the set of address ranges of shared virtual storage 212 allocated to allocating thread 208. Also, associated shared virtual storage address ranges 216 correspond to list of virtual addresses 214. Shared virtual storage manager 206 stores list of virtual addresses 214 and associated shared virtual storage address ranges 216 in control information corresponding to associated shared virtual storage address ranges 216 for future reference.

In this example, access requesting thread 210 is requesting access to a shared virtual storage address range allocated to allocating thread 208. It should be noted that access requesting thread 210 may or may not be the same as allocating thread 208. In response to receiving the access request, shared virtual storage manager 206 identifies the virtual address of the current instruction of access requesting thread 210 in a program status word corresponding to access requesting thread 210. Further, shared virtual storage manager 206 retrieves list of virtual addresses 214 and associated shared virtual storage address ranges 216 from the control information corresponding to associated shared virtual storage address ranges 216.

Afterward, shared virtual storage manager 206 determines whether the virtual address of the current instruction corresponding to access requesting thread 210 is included in list of virtual addresses 214 permitted to access any of associated shared virtual storage address ranges 216 allocated to allocating thread 208. In response to determining that the virtual address of the current instruction corresponding to access requesting thread 210 is included in list of virtual addresses 214, shared virtual storage manager 206 determines that access requesting thread 210 is an authorized thread and permits the access to associated shared virtual storage address ranges 216 by access requesting thread 210. Conversely, in response to determining that the virtual address of the current instruction corresponding to access requesting thread 210 is not included in list of virtual addresses 214, shared virtual storage manager 206 determines that access requesting thread 210 is an unauthorized thread and denies the access to associated shared virtual storage address ranges 216 by access requesting thread 210.

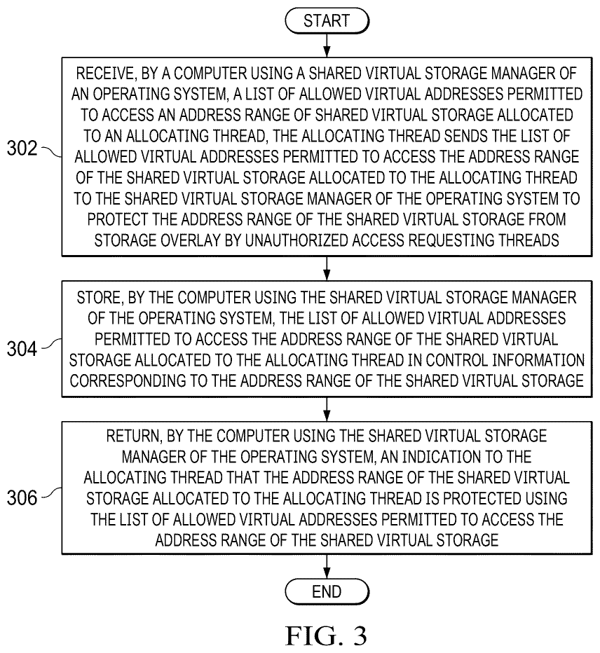

With reference now to FIG. 3, a flowchart illustrating a process for protecting a shared virtual storage address range from storage overlay is shown in accordance with an illustrative embodiment. The process shown in FIG. 3 may be implemented in a computer, such as, for example, computer 101 in FIG. 1 or computer 202 in FIG. 2. For example, the process shown in FIG. 3 may be implemented by shared virtual storage management code 200 in FIG. 1.

The process begins when the computer, using a shared virtual storage manager of an operating system, receives a list of allowed virtual addresses permitted to access an address range of shared virtual storage allocated to an allocating thread (operation 302). The allocating thread sends the list of allowed virtual addresses permitted to access the address range of the shared virtual storage allocated to the allocating thread to the shared virtual storage manager of the operating system to protect the address range of the shared virtual storage from storage overlay by unauthorized access requesting threads. However, it should be noted that in alternative illustrative embodiments the allocating thread may send a list of denied virtual addresses that are not permitted to access the address range of the shared virtual storage allocated to the allocating thread in addition to, or instead of, the list of allowed virtual addresses.

The computer, using the shared virtual storage manager of the operating system, stores the list of allowed virtual addresses permitted to access the address range of the shared virtual storage allocated to the allocating thread in control information corresponding to the address range of the shared virtual storage (operation 304). The computer, using the shared virtual storage manager of the operating system, returns an indication to the allocating thread that the address range of the shared virtual storage allocated to the allocating thread is protected using the list of allowed virtual addresses permitted to access the address range of the shared virtual storage (operation 306). Thereafter, the process terminates.

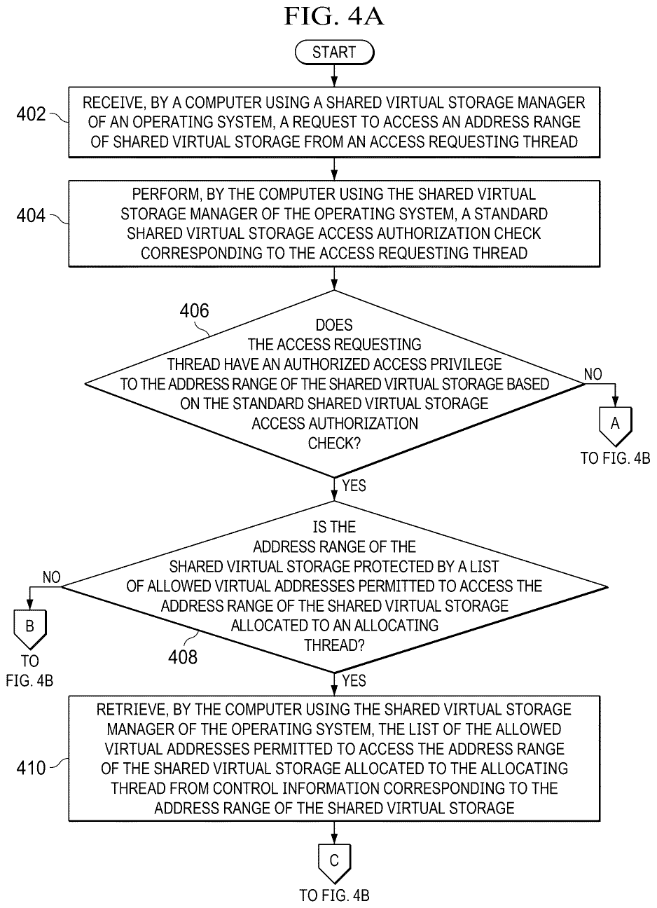

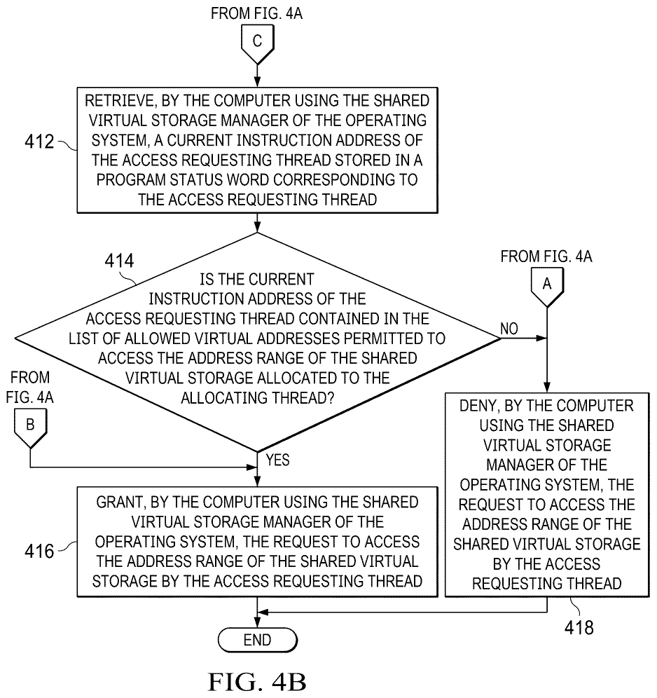

With reference now to FIGS. 4A-4B, a flowchart illustrating a process for limiting access to a shared virtual storage address range is shown in accordance with an illustrative embodiment. The process shown in FIGS. 4A-4B may be implemented in a computer such as, for example, computer 101 in FIG. 1 or computer 202 in FIG. 2. For example, the process shown in FIGS. 4A-4B may be implemented by shared virtual storage management code 200 in FIG. 1.

The process begins when the computer, using a shared virtual storage manager of an operating system, receives a request to access an address range of shared virtual storage from an access requesting thread (operation 402). The computer, using the shared virtual storage manager of the operating system, performs a standard shared virtual storage access authorization check corresponding to the access requesting thread (operation 404). The standard shared virtual storage access authorization check may be, for example, a particular storage protect key needed by the access requesting thread to access that particular address range of shared virtual storage.

The computer, using the shared virtual storage manager of the operating system, makes a determination as to whether the access requesting thread has an authorized access privilege to the address range of the shared virtual storage based on the standard shared virtual storage access authorization check (operation 406). If the computer, using the shared virtual storage manager of the operating system, determines that the access requesting thread does not have an authorized access privilege to the address range of the shared virtual storage based on the standard shared virtual storage access authorization check, it results in a no output of operation 406, then the process proceeds to operation 418.

If the computer, using the shared virtual storage manager of the operating system, determines that the access requesting thread does have the authorized access privilege to the address range of the shared virtual storage based on the standard shared virtual storage access authorization check, it results in a yes output of operation 406. After the yes output of operation 406, the computer, using the shared virtual storage manager of the operating system, makes a determination as to whether the address range of the shared virtual storage is protected by a list of allowed virtual addresses permitted to access the address range of the shared virtual storage allocated to an allocating thread (operation 408).

If the computer, using the shared virtual storage manager of the operating system, determines that the address range of the shared virtual storage is not protected by a list of allowed virtual addresses permitted to access the address range of the shared virtual storage allocated to an allocating thread, it results in a no output of operation 408 and then the process proceeds to operation 416.

If the computer, using the shared virtual storage manager of the operating system, determines that the address range of the shared virtual storage is protected by a list of allowed virtual addresses permitted to access the address range of the shared virtual storage allocated to an allocating thread, it results in a yes output of operation 408. After the yes output of operation 408, the computer, using the shared virtual storage manager of the operating system, retrieves the list of the allowed virtual addresses permitted to access the address range of the shared virtual storage allocated to the allocating thread from control information corresponding to the address range of the shared virtual storage (operation 410). In addition, the computer, using the shared virtual storage manager of the operating system, retrieves a current instruction address of the access requesting thread stored in a program status word corresponding to the access requesting thread (operation 412).

Afterward, the computer, using the shared virtual storage manager of the operating system, makes a determination as to whether the current instruction address of the access requesting thread is contained in the list of allowed virtual addresses permitted to access the address range of the shared virtual storage allocated to the allocating thread (operation 414). If the computer, using the shared virtual storage manager of the operating system, determines that the current instruction address of the access requesting thread is contained in the list of allowed virtual addresses permitted to access the address range of the shared virtual storage allocated to the allocating thread, it results in a yes output of operation 414. After the yes output of operation 414, the computer, using the shared virtual storage manager of the operating system, grants the request to access the address range of the shared virtual storage by the access requesting thread (operation 416). Thereafter, the process terminates.

If the computer, using the shared virtual storage manager of the operating system, determines that the current instruction address of the access requesting thread is not contained in the list of allowed virtual addresses permitted to access the address range of the shared virtual storage allocated to the allocating thread, it results in a no output of operation 414. After the no output of operation 414, the computer, using the shared virtual storage manager of the operating system, denies the request to access the address range of the shared virtual storage by the access requesting thread (operation 418). Thereafter, the process terminates.

Thus, illustrative embodiments of the present disclosure provide a computer-implemented method, computer system, and computer program product for limiting access to a shared virtual storage address range using a list of allowed virtual addresses permitted to access the shared virtual storage address range allocated to an allocating thread. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
determining whether a current instruction address of an access requesting thread is contained in a list of allowed virtual addresses permitted to access an address range of shared virtual storage allocated to an allocating thread; and
responsive to determining that the current instruction address of the access requesting thread is contained in the list of allowed virtual addresses permitted to access the address range of the shared virtual storage allocated to the allocating thread, granting a request to access the address range of the shared virtual storage by the access requesting thread.

2. The method of claim 1, further comprising:
responsive to determining that the current instruction address of the access requesting thread is not contained in the list of allowed virtual addresses permitted to access the address range of the shared virtual storage allocated to the allocating thread, denying the request to access the address range of the shared virtual storage by the access requesting thread.

3. The method of claim 1, further comprising:
receiving the list of allowed virtual addresses permitted to access the address range of the shared virtual storage allocated to the allocating thread, the allocating thread sends the list of allowed virtual addresses permitted to access the address range of the shared virtual storage allocated to the allocating thread to a shared virtual storage manager of an operating system to protect the address range of the shared virtual storage from storage overlay by unauthorized access requesting threads.

4. The method of claim 3, further comprising:
storing, by the shared virtual storage manager of the operating system, the list of allowed virtual addresses permitted to access the address range of the shared virtual storage allocated to the allocating thread in control information corresponding to the address range of the shared virtual storage; and
returning an indication to the allocating thread that the address range of the shared virtual storage allocated to the allocating thread is protected using the list of allowed virtual addresses permitted to access the address range of the shared virtual storage.

5. The method of claim 1, further comprising:
receiving the request to access the address range of the shared virtual storage from the access requesting thread; and
performing a standard shared virtual storage access authorization check corresponding to the access requesting thread.

6. The method of claim 5, further comprising:
determining whether the access requesting thread has an authorized access privilege to the address range of the shared virtual storage based on the standard shared virtual storage access authorization check; and
responsive to determining that the access requesting thread does have the authorized access privilege to the address range of the shared virtual storage based on the standard shared virtual storage access authorization check, determining whether the address range of the shared virtual storage is protected by the list of allowed virtual addresses permitted to access the address range of the shared virtual storage allocated to the allocating thread.

7. The method of claim 6, further comprising:
responsive to determining that the address range of the shared virtual storage is protected by the list of allowed virtual addresses permitted to access the address range of the shared virtual storage allocated to the allocating thread, retrieving the list of the allowed virtual addresses permitted to access the address range of the shared virtual storage allocated to the allocating thread from control information corresponding to the address range of the shared virtual storage; and
retrieving the current instruction address of the access requesting thread stored in a program status word corresponding to the access requesting thread.

8. A computer system comprising:
a processor set;
one or more computer-readable storage media; and
program instructions stored on the one or more computer-readable storage media to cause the processor set to perform operations comprising:
determining whether a current instruction address of an access requesting thread is contained in a list of allowed virtual addresses permitted to access an address range of shared virtual storage allocated to an allocating thread; and
responsive to determining that the current instruction address of the access requesting thread is contained in the list of allowed virtual addresses permitted to access the address range of the shared virtual storage allocated to the allocating thread, granting a request to access the address range of the shared virtual storage by the access requesting thread.

9. The computer system of claim 8, wherein the operations further comprise:
responsive to determining that the current instruction address of the access requesting thread is not contained in the list of allowed virtual addresses permitted to access the address range of the shared virtual storage allocated to the allocating thread, denying the request to access the address range of the shared virtual storage by the access requesting thread.

10. The computer system of claim 8, wherein the operations further comprise:
receiving the list of allowed virtual addresses permitted to access the address range of the shared virtual storage allocated to the allocating thread, the allocating thread sends the list of allowed virtual addresses permitted to access the address range of the shared virtual storage allocated to the allocating thread to a shared virtual storage manager of an operating system to protect the address range of the shared virtual storage from storage overlay by unauthorized access requesting threads.

11. The computer system of claim 10, wherein the operations further comprise:
storing, by the shared virtual storage manager of the operating system, the list of allowed virtual addresses permitted to access the address range of the shared virtual storage allocated to the allocating thread in control information corresponding to the address range of the shared virtual storage; and
returning an indication to the allocating thread that the address range of the shared virtual storage allocated to the allocating thread is protected using the list of allowed virtual addresses permitted to access the address range of the shared virtual storage.

12. The computer system of claim 8, wherein the operations further comprise:
receiving the request to access the address range of the shared virtual storage from the access requesting thread; and
performing a standard shared virtual storage access authorization check corresponding to the access requesting thread.

13. The computer system of claim 12, wherein the operations further comprise:
determining whether the access requesting thread has an authorized access privilege to the address range of the shared virtual storage based on the standard shared virtual storage access authorization check; and
responsive to determining that the access requesting thread does have the authorized access privilege to the address range of the shared virtual storage based on the standard shared virtual storage access authorization check, determining whether the address range of the shared virtual storage is protected by the list of allowed virtual addresses permitted to access the address range of the shared virtual storage allocated to the allocating thread.

14. A computer program product comprising:
one or more computer-readable storage media; and
program instructions stored on the one or more computer-readable storage media to perform operations comprising:
determining whether a current instruction address of an access requesting thread is contained in a list of allowed virtual addresses permitted to access an address range of shared virtual storage allocated to an allocating thread; and
responsive to determining that the current instruction address of the access requesting thread is contained in the list of allowed virtual addresses permitted to access the address range of the shared virtual storage allocated to the allocating thread, granting a request to access the address range of the shared virtual storage by the access requesting thread.

15. The computer program product of claim 14, wherein the operations further comprise:
responsive to determining that the current instruction address of the access requesting thread is not contained in the list of allowed virtual addresses permitted to access the address range of the shared virtual storage allocated to the allocating thread, denying the request to access the address range of the shared virtual storage by the access requesting thread.

16. The computer program product of claim 14, wherein the operations further comprise:
receiving the list of allowed virtual addresses permitted to access the address range of the shared virtual storage allocated to the allocating thread, the allocating thread sends the list of allowed virtual addresses permitted to access the address range of the shared virtual storage allocated to the allocating thread to a shared virtual storage manager of an operating system to protect the address range of the shared virtual storage from storage overlay by unauthorized access requesting threads.

17. The computer program product of claim 16, wherein the operations further comprise:
storing, by the shared virtual storage manager of the operating system, the list of allowed virtual addresses permitted to access the address range of the shared virtual storage allocated to the allocating thread in control information corresponding to the address range of the shared virtual storage; and
returning an indication to the allocating thread that the address range of the shared virtual storage allocated to the allocating thread is protected using the list of allowed virtual addresses permitted to access the address range of the shared virtual storage.

18. The computer program product of claim 14, wherein the operations further comprise:
receiving the request to access the address range of the shared virtual storage from the access requesting thread; and
performing a standard shared virtual storage access authorization check corresponding to the access requesting thread.

19. The computer program product of claim 18, wherein the operations further comprise:
determining whether the access requesting thread has an authorized access privilege to the address range of the shared virtual storage based on the standard shared virtual storage access authorization check; and
responsive to determining that the access requesting thread does have the authorized access privilege to the address range of the shared virtual storage based on the standard shared virtual storage access authorization check, determining whether the address range of the shared virtual storage is protected by the list of allowed virtual addresses permitted to access the address range of the shared virtual storage allocated to the allocating thread.

20. The computer program product of claim 19, wherein the operations further comprise:
responsive to determining that the address range of the shared virtual storage is protected by the list of allowed virtual addresses permitted to access the address range of the shared virtual storage allocated to the allocating thread, retrieving the list of the allowed virtual addresses permitted to access the address range of the shared virtual storage allocated to the allocating thread from control information corresponding to the address range of the shared virtual storage; and
retrieving the current instruction address of the access requesting thread stored in a program status word corresponding to the access requesting thread.
